(19) United States
(12) Patent Application Publication
(10) Pub. No.: US 2026/0252289 A1
(43) Pub. Date: Aug. 27, 2026

(54) INFORMATION PROCESSING APPARATUS, METHOD FOR CONTROLLING INFORMATION PROCESSING APPARATUS, AND PRINTING SYSTEM

(71) Applicant: CANON KABUSHIKI KAISHA, Tokyo (JP)

(72) Inventor: YOSHIJI KANAMOTO, Tokyo (JP)

(21) Appl. No.: 19/538,765

(22) Filed: Feb. 12, 2026

(30) Foreign Application Priority Data
Feb. 26, 2025 (JP) 2025-029538

(51) Int. Cl. G06F 3/12

(52) U.S. Cl. CPC G06F 3/1257; G06F 3/1205; G06F 3/1253

(57) ABSTRACT

A method for controlling an information processing apparatus including a general-purpose printing program and an auxiliary printing program both configured to run on an operating system, a storage configured to store print settings, and a display, the method includes determining, by the general-purpose printing program, that a perfect binding function is selected as a function of an accepted print job, and in response to the determination, controlling the auxiliary printing program to display a setting screen for the perfect binding function on the display and to accept one or more settings for the perfect binding function.

### BACKGROUND

### Field of the Technology

The present disclosure relates to an information processing apparatus, a method for controlling an information processing apparatus, and a printing system.

### Description of the Related Art

General-purpose print drivers that communicate directly with image forming apparatuses using industry-standard protocols such as the Internet Printing Protocol (IPP) have been contemplated in recent years. General-purpose print drivers can communicate with printers from multiple printer vendors. Using general-purpose print drivers, users can thus transmit print jobs to information processing apparatuses without installing vendor-specific print drivers. For example, Japanese Patent Laid-Open No. 2021-108001 describes an IPP class driver as an example of a general-purpose print driver.

Since the foregoing general-purpose print drivers handle print jobs to be printed by image forming apparatuses from various vendors, items and functions configurable as print settings are limited. In other words, all print settings of print drivers provided by printer vendors have not been provided by the mechanism of standard general-purpose print drivers. Moreover, means for configuring print settings and the like required of jobs for producing products involving complex processing have not been provided by general-purpose print drivers, either.

Examples include perfect binding (or case binding) processing in which a plurality of sheets constituting a book block is wrapped with a cover having a sheet size larger than that of the book block, glued, and finished into a bound form. For such perfect binding processing, the foregoing general-purpose print drivers have not provided any setting means, processing for print job data based on the setting means, or processing for configuring setting values to be transmitted to image forming apparatuses.

### SUMMARY

The present disclosure is directed to a mechanism for implementing a perfect binding print setting function, which has been challenging to achieve with general-purpose print drivers alone.

According to an aspect of the present disclosure, a method for controlling an information processing apparatus including a general-purpose printing program and an auxiliary printing program both configured to run on an operating system, a storage configured to store print settings, and a display, the method includes determining, by the general-purpose printing program, that a perfect binding function is selected as a function of an accepted print job, and in response to the determination, controlling the auxiliary printing program to display a setting screen for the perfect binding function on the display and to accept one or more settings for the perfect binding function

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an overall configuration of a printing system according to a first embodiment.

FIG. 2 is a hardware configuration diagram of a client terminal according to the first embodiment.

FIG. 3 is a software configuration diagram of the client terminal according to the first embodiment.

FIGS. 4A to 4C are conceptual explanation diagrams of perfect binding processing according to the first embodiment.

FIG. 5 is an internal configuration diagram of a perfect binding unit according to the first embodiment.

FIGS. 6A to 6H illustrate page order control of a cover and a book block by the perfect binding processing according to the first embodiment.

FIG. 7 is a timing chart of the perfect binding processing according to the first embodiment.

FIG. 8 illustrates a display screen of a document generation application according to the first embodiment.

FIG. 9 illustrates a print queue selection screen according to the first embodiment.

FIGS. 10A and 10B each illustrate a print setting screen of a general-purpose print driver/print setting extension application according to the first embodiment.

FIGS. 10C and 10D each illustrate a print setting screen of the general-purpose print driver/print setting extension application according to the first embodiment.

FIG. 10E illustrates a print setting screen of the general-purpose print driver/print setting extension application according to the first embodiment.

FIG. 10F illustrates value ranges off perfect binding-related setting items according to the first embodiment.

FIGS. 11A and 11B are sequence diagrams during configuration/execution of the perfect binding processing according to the first embodiment.

FIG. 12 is a flowchart of print setting processing in the client terminal according to the first embodiment.

FIG. 13 is a flowchart of print setting processing of the print setting extension application in the client terminal according to the first embodiment.

FIGS. 14A and 14B are a flowchart of perfect binding print setting processing in the client terminal according to the first embodiment.

FIG. 15 illustrates a print setting screen of a print setting extension application according to a second embodiment.

FIGS. 16A and 16B each illustrate a print setting screen of a print setting extension application according to a third embodiment.

### DESCRIPTION OF THE EMBODIMENTS

Embodiments of the present disclosure will be described in detail below with reference to the drawings. The following embodiments are not intended to limit the disclosure set forth in the claims, and not all combinations of features described in the embodiments are necessarily essential to the solving means of the disclosure.

### FIRST EMBODIMENT

### Overall Configuration of Printing System

Initially, a first embodiment of the present disclosure will be described.

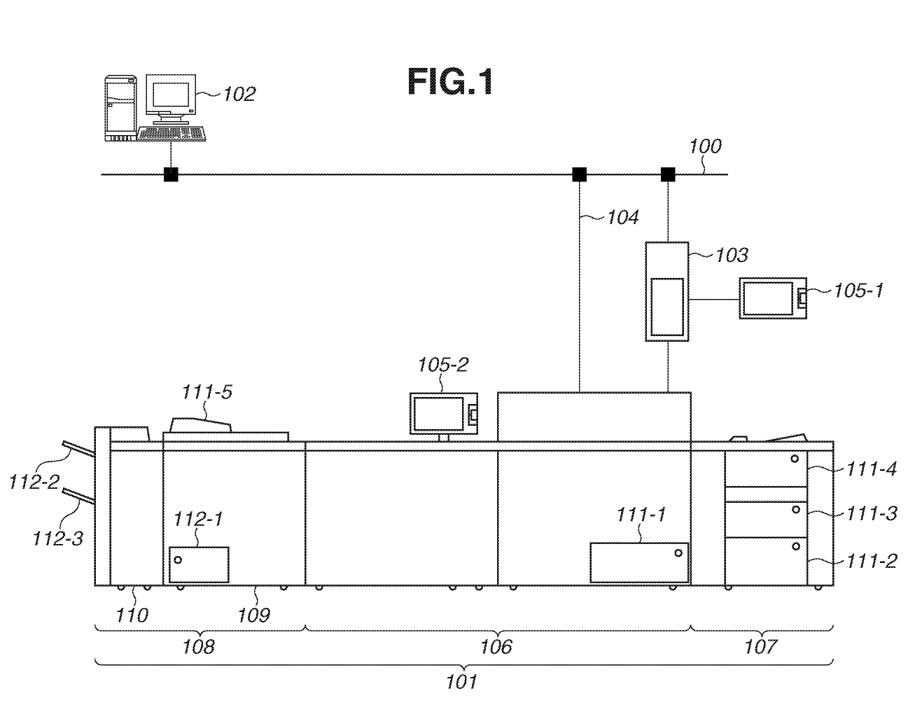

FIG. 1 is a block diagram illustrating a printing system according to the present embodiment. In the present embodiment, a multifunction peripheral (MFP) 101 will be described as an example of an image forming apparatus, and a client terminal 102 that is a personal computer (PC) as an example of an information processing apparatus. The MFP 101 and the client terminal 102 are communicatively connected via a network 100.

While FIG. 1 illustrates a case where the printing system includes a single information processing apparatus, the printing system may be configured so that the MFP 101 and a plurality of information processing apparatuses are communicatively connected via the network 100.

### Client Terminal

The client terminal 102 that is an information processing apparatus will initially be described. The client terminal 102 can execute various programs including an application program for performing operations to generate and edit print job data and submit the print job data to the MFP 101. A print driver that is a printing program having a function of converting print data into a printer language compatible with the MFP 101 is installed on the client terminal 102. The present embodiment demonstrates a case where the print driver is not one provided by the printer vendor, and a general-purpose print driver that is a general-purpose printing program provided by the vendor of the operating system running on the client terminal 102 is installed. The following description will be given on the assumption that the print driver is a general-purpose print driver.

Users who wish to print can issue print instructions using the foregoing various application programs. After necessary print settings are configured on the general-purpose print driver, data to be printed output from the applications can be converted into print job data interpretable by the MFP 101 based on the settings and transmitted to the MFP 101 via the network 100. As will be described below, the general-purpose print driver that is the foregoing general-purpose printing program is not capable of configuring settings by itself that need complex setting items, like those of perfect binding jobs. This printing system thus introduces an auxiliary printing program and thereby enables the MFP 101 to implement perfect-bound product fabrication processing through configuration of various settings needed for perfect binding.

### MFP

Next, the MFP 101 will be described. The MFP 101 has a print function of printing images on sheets. The MFP 101 also has postprocessing functions of binding a plurality of image-printed sheets, aligning a plurality of sheets, and sorting the discharge destination of multiple sheets among multiple trays. Various types of sheets can be used, including sheets of paper such as plain paper, thick paper, and coated paper, as well as films. In the present embodiment, as an example, the image forming apparatus shall include various configurations to be described below.

An external controller device called digital front end (DFE) 103, which is an apparatus having some of the functions of the MFP 101 or other accessory functions, may be added to the MFP 101. In such a case, it may appear to the client terminal 102 that the DFE 103 is providing the functions of the MFP 101 instead via the network 100. The DFE 103 can be accompanied by various input/output devices similar to those of the client terminal 102, such as a monitor 105-1. Even with such an accessory DFE 103 attached, the MFP 101 may be configured to be directly connectible to the network 100 using a network cable 104.

The printing system where the DFE 103 is connected may be configured so that the monitor 105-1 is used as display and operation units of the DFE 103. Note that the MFP 101 according to the present disclosure may also be configured so that an operation unit 105-2 is used as display and operation units of the DFE 103.

The MFP 101 is configured so that a plurality of apparatuses with different roles is interconnected to enable complicated sheet processing. The components of the MFP 101 will now be described.

A printer unit 106 forms (prints) images using toner on media (sheets) fed from sheet feeding units based on image data. The configuration and operation principle of this printer unit 106 are as follows.

A light beam, such as laser light, modulated based on the image data is reflected by a rotating polygonal mirror (polygon mirror, etc.) to irradiate a photosensitive drum as scanning light. An electrostatic latent image formed on the photosensitive drum by this laser light is developed with toner, and the toner image is transferred to a sheet attached to a transfer drum. This series of image forming processes is performed with yellow (Y), magenta (M), cyan (C), and black (K) toners in succession, whereby a full-color image is formed on the sheet. In addition to the foregoing four colors, the printer unit 106 may be configured to be capable of transferring spot color toner, transparent toner, etc. The sheet on the transfer drum on which a full-color image is thus formed is conveyed to a fixing device. The fixing device includes a roller and a belt, with a built-in heat source such as a halogen heater inside the roller. The toner on the sheet to which the toner image is transferred is melted by heat and pressure and thereby fixed to the sheet.

The MFP 101 according to the present embodiment is configured so that an appropriate print speed mode and image processing mode for the foregoing printer unit 106 to apply during printing are selected depending on the type and grammage of sheets that the MFP 101 uses during the print processing.

The printer unit 106 of the MFP 101, which is described as an example in the present embodiment, is equipped with the operation unit 105-2 on its top. The operation unit 105-2 provides various interfaces when the user configures various settings of the printer unit 106 and performs various operations etc.

The MFP 101 is further configured so that various accessory devices can be attached to the printer unit 106.

A large-capacity sheet feeding apparatus 107 is a sheet feeding apparatus detachably attachable to the printer unit 106. This sheet feeding apparatus includes a plurality of sheet feeding units (111-2, 111-3, and 111-4). With such a configuration, the printer unit 106 can perform print processing on large volumes of sheets. In the example illustrated in the diagram, the printer unit 106 itself is also configured to include a sheet feeding unit 111-1.

A perfect binding unit 109 is an apparatus used when producing a bound product by wrapping a plurality of stacked sheets with a cover sheet of greater size, followed by gluing and trimming. The completed perfect-bound product is output to a tray 112-1. The perfect binding unit 109 illustrated in the diagram demonstrates an example of a configuration with an insert tray 111-5 so that preprinted sheets can be used as covers. The configuration and operation principal of the apparatus, the structure of the perfect-bound product, and the like will be described below.

A processing apparatus 110 is provided to staple bundles of sheets. Possible types of stapling include corner stapling, two-point stapling, and other user-desired modes of stapling processing. The processed products, if corner-stapled or two-point-stabled, are output to trays 112-2 and 112-3.

This MFP 101 can be broadly divided into three sections with the printer unit 106 at the center. In FIG. 1, the device on the right of the printer 106 is referred to as a sheet feeding system apparatus 107. The primary role of the sheet feeding system apparatus 107 is to continuously feed sheets loaded inside to the printer unit 106 at appropriate timing. The printer unit 106 also includes the sheet feeding unit 111-1, which can perform functions similar to those of the sheet feeding system apparatus 107. In the following description, this sheet feeding unit 111-1 directly included in the printer unit 106 is also referred to as the sheet feeding system apparatus.

In FIG. 1, the devices on the left of the printer unit 106 are referred to as a sheet processing apparatus 108. The sheet processing apparatus 108 is also referred to as a postprocessing apparatus. The sheet processing apparatus 108 applies various types of processing to sheets of which the print processing is completed, or stacks or otherwise processes the sheets.

### Hardware Configuration Client Terminal

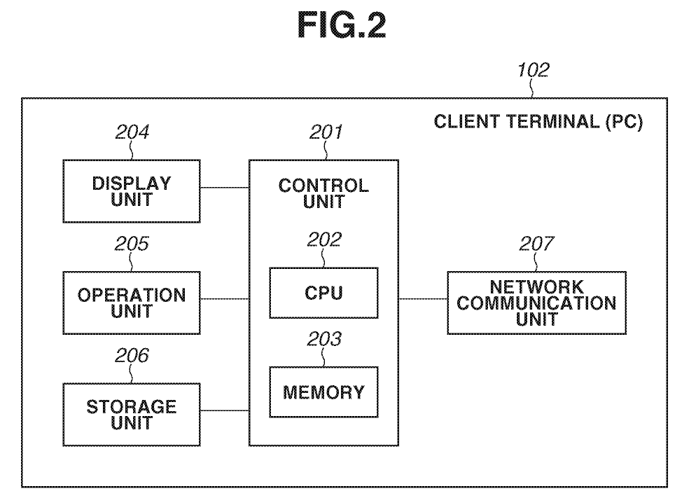

FIG. 2 is a block diagram illustrating a hardware configuration of the client terminal 102.

The client terminal 102 includes a display unit 204, an operation unit 205, a storage unit 206, a control unit 201, and a network communication unit 207.

The storage unit 206 refers to a nonvolatile storage device such as a hard disk and a solid-state drive (SSD), and can store and rewrite digital data.

The control unit 201 includes a central processing unit (CPU) 202 and a memory 203, and controls operation of the entire client terminal 102.

The CPU 202 loads programs stored in the storage unit 206 into the memory 203, and executes the programs.

The memory 203 is a main storage memory of the CPU 202, and used as a work area and a temporary storage area for loading various programs.

The network communication unit 207 is a device for communicating with the network 100, and inputs and outputs digital data from/to external servers, client terminals, the MFP 101, and the like via the network 100.

The display unit 204 is a device for displaying visual information to users in real time. Examples include a liquid crystal display.

The operation unit 205 is a device for accepting user input via a keyboard, mouse, and the like. Devices having the functions of both the display unit 204 and the operation unit 205, like a touchscreen, may be used.

### Software Configuration Client Terminal

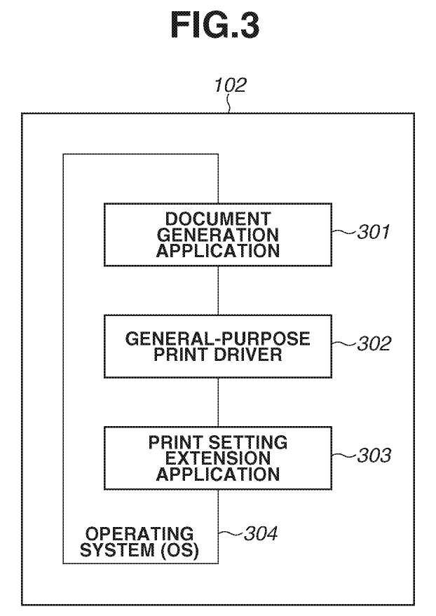

FIG. 3 is a block diagram illustrating a software configuration of the client terminal 102. The components illustrated in the diagram constitute the minimum configuration needed to describe the effects of the present embodiment.

A document generation application 301 is a general term for various applications that generate and edit data to be printed.

A general-purpose print driver 302 is a program module to be called and executed by the document generation application 301, and a module for converting application data generated by the document generation application 301 into printable print job data. The general-purpose print driver 302 is characterized by its versatility, being provided together with an operating system 304, and unlike print drivers generated by printer vendors, is used for common general printing purposes and print setting configuration. The client terminal 102 includes and can use this general-purpose print driver 302, a general-purpose printing program. When the document generation application 301 performs print processing on the MFP 101, vendor-specific print drivers prepared by the vendor of the MFP 101 therefore do not need to be used. This enables print processing on image forming apparatuses including any MFPs from any vendors, using the common mechanism.

However, the foregoing mechanism, despite its high versatility, is difficult to use for product fabrication processing purposes with print settings involving functions specific to the vendor or the MFP 101 or complex settings. The print setting extension application 303 (hereinafter, may be referred to as an "extension application"), which is an auxiliary printing program, is a module for compensating this shortcoming.

The operating mechanism itself of the print setting extension application 303 is provided along with the mechanism where the operating system 304 and the general-purpose print driver 302, which is a general-purpose printing program, operate.

By contrast, the print setting extension application 303 is configured to be introducible such that it can be additionally provided by the vendor or the like of the MFP 101 and run on the client terminal 102 as needed.

There are many print setting processes that are not executable with the general-purpose print drive 302 alone but become executable through the addition of the print setting extension application 303, which is an auxiliary printing program. The present embodiment demonstrates the setting of perfect binding (or case binding) print processing as an example.

### Structure and Fabrication Method of Perfect-Bound Product

### Structure of Perfect-Bound Product

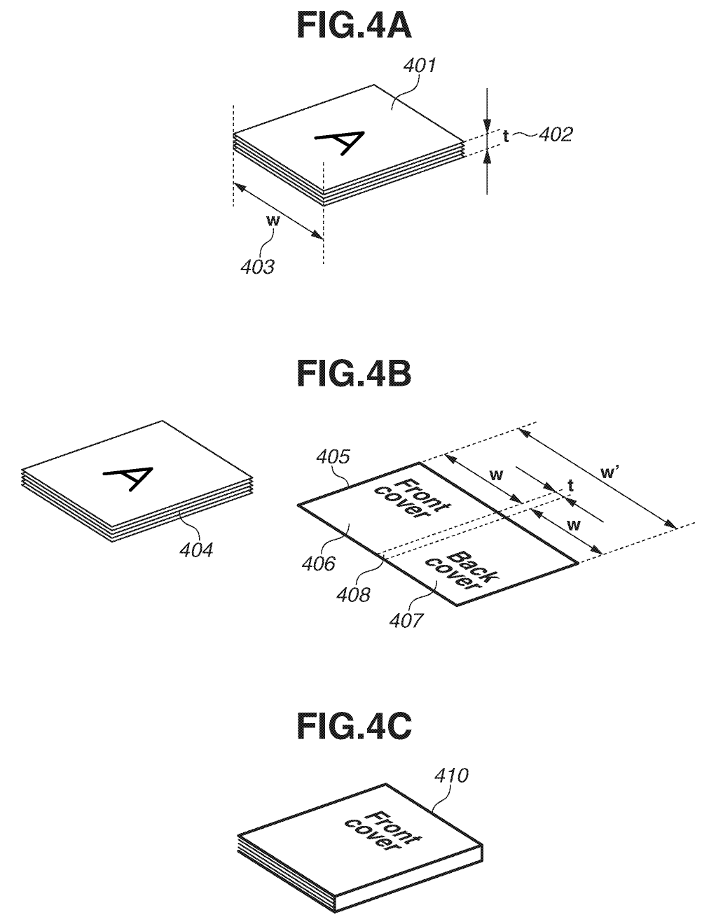

FIGS. 4A to 4C are diagrams for describing an outline of the structure of a perfect-bound product and a fabrication method thereof.

Initially, a plurality of sheets corresponding to a book block 401 of the perfect-bound product is stacked as illustrated in FIG. 4A. FIG. 4A illustrates a case where the stacked sheets have the same width (w) 403, with a stacked sheet thickness (t) 402.

Glue is applied to the book block 401 in this state at the portion corresponding to a spine portion 404 of the perfect-bound product. The purpose is to subsequently adhesively bond a perfect binding cover sheet 405 to the spine portion 404 as illustrated in FIG. 4B and fold the perfect binding cover sheet 405 to fabricate a perfect-bound product 410 as illustrated in FIG. 4C.

The perfect binding cover needs to be a sheet having a size (w') that is the sum of a width (w) of a front cover portion 406, a width (w) of a back cover portion 407, and a thickness (t) of a spine portion 408 of the perfect-bound product 410. Moreover, if trimming is taken into consideration, a perfect binding cover sheet 405 greater than the total size needs to be used to fabricate the perfect-bound product 410.

The settings for the perfect binding cover sheet 405 need to take into consideration the selection of images that constitute the front cover portion 406 and back cover portion 407, and the thickness (t) of the spine portion 408. Imposition processing, processing for selecting a sheet size capable of printing with the imposed image sizes, a thickness specification method, and the like are then examined and set. In other words, a plurality of mutually related complex settings needs to be correctly and appropriately configured at the same time.

### Configuration of Perfect Binding Unit

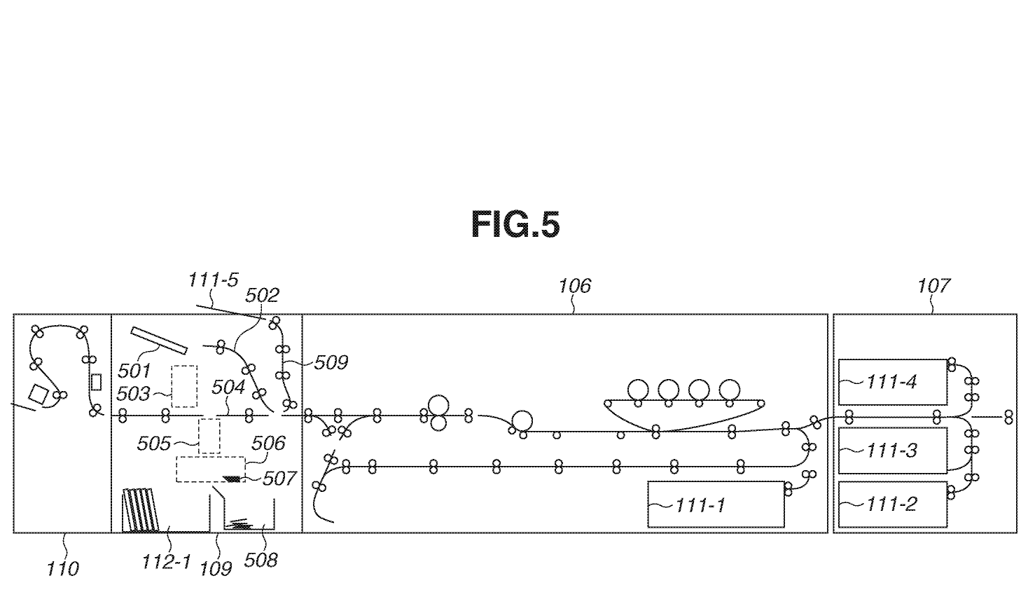

FIG. 5 is a diagram for describing conveyance paths in the MFP 101 illustrated in FIG. 1, as well as an internal configuration and operation principle of the perfect binding unit 109.

Initially, sheets corresponding to the book block 401 illustrated in FIG. 4 are fed from one of the sheet feeding units (111-1 to 111-4), and the printer unit 106 performs image formation. The sheets are stacked on a stacking tray 501 in the perfect binding unit 109 via a conveyance path 502.

When the stacking of the sheets of the book block 401 is completed, a perfect binding cover sheet 405 is conveyed from a sheet feeding unit other than that which has fed the sheets of the book block 401, or from the insert tray 111-5 and a conveyance path 509, to a conveyance path 504.

In parallel with the cover image formation or conveyance processing described above, a gluing unit 503 applies glue to the spine portion 404 of the book block 401 stacked on the stacking tray 501.

The gluing unit 503 performs adhesive bonding processing once the spine portion 408 of the perfect binding cover sheet 405 conveyed to the conveyance path 504 and the spine portion of the glued book block 401 are aligned in position.

The adhesively bonded book block 401 and perfect bonding cover sheet 405 are then guided into a folding unit 505. The folding unit 505 folds the perfect binding cover sheet 405 into a shape such that the front cover portion 406 and the back cover portion 407 extend along the book block 401 with the spine portion 408 therebetween. The folded article is then guided into a trimming unit 506, and trimmed by a cutter 507 included in the trimming unit 506. Note that whether to perform the trimming processing depends on setting information about the perfect-bound product fabrication step, and the perfect-bound product fabrication processing may be performed without the trimming processing.

After the trimming processing is performed by the trimming unit 506, trimming waste and the fabricated product are separated from each other and guided into a trash bin 508 and the tray 112-1, respectively.

What is described above is the perfect-bound product fabrication step performed by the perfect binding unit 109, as well as the internal configuration and operation principle of the perfect binding unit 109.

### Perfect Binding Processing

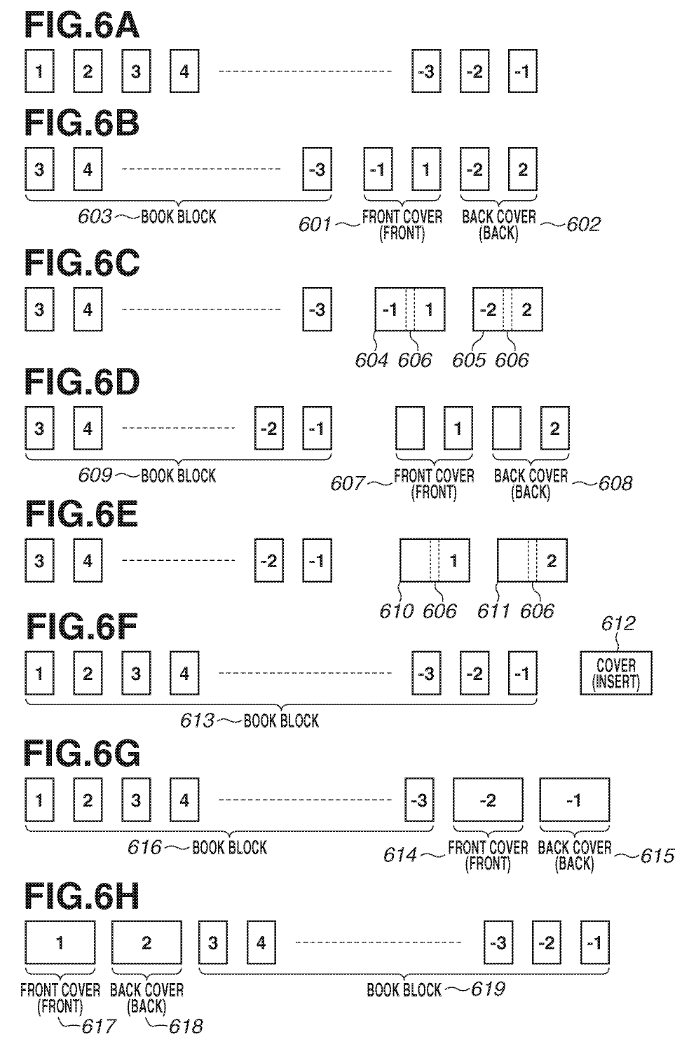

FIGS. 6A to 6H are diagrams for describing details of page order control of the cover and book block in perfect binding processing, and imposition processing of the cover portions. The following description will be given on the assumption that FIG. 6A illustrates document data generated by the document generation application 301. FIG. 6A illustrates pages constituting the document in order of suffixes. In this diagram and subsequent diagrams, positive numerals indicate page numbers from the beginning of the document data, and negative numerals page numbers from the end of the document data.

FIG. 6B is a diagram illustrating an example of a state where the page order of the document data illustrated in FIG. 6A is rearranged to form the cover portions of the perfect-bound product. As illustrated in the diagram, the page order is rearranged so that a front cover 601 is composed of two pages: the first page that is the initial page of the document data and the -1st page, i.e., the last page. FIG. 6B also illustrates that the page order is rearranged so that a back cover 602 is composed of two pages: the second page from the beginning of the document data and the -2nd page from the end.

The diagram also illustrates a state where a book block 603 is composed of the pages remaining after the composition of the foregoing front cover 601 and back cover 602, i.e., the third page to the -3rd page.

FIG. 6C is a diagram for describing a state where the front cover 601, the back cover 602, and the book block 603 are printed on sheets after the page order is rearranged as illustrated in FIG. 6B. The diagram illustrates a situation where a cover sheet front 604 and a cover sheet back 605 are imposed with those pages illustrated in FIG. 6B. Note that FIG. 6C illustrates a situation where the pages are imposed to leave a gap as much as the spine width, or a book block bundle thickness 606, to form the spine portion of the perfect-bound product. Since the perfect binding spine portion has been described in detail with reference to FIG. 4B, a detailed description thereof will be omitted.

FIG. 6D is a diagram illustrating another example of the state where the page order of the document data illustrated in FIG. 6B is rearranged to form the cover portions of the perfect-bound product. As illustrated in the diagram, the page order is rearranged so that a front cover 607 is composed only of the first page that is the initial page of the document data. FIG. 6D also illustrates a state where the page order is rearranged so that a back cover 608 is composed only of the second page of the document data.

FIG. 6D illustrates a state where a book block 609 is composed of the pages remaining after the composition of the foregoing front cover 607 and back cover 608, i.e., the third page to the -1st page.

FIG. 6E is a diagram for describing a state where the front cover 607, the back cover 608, and the book block 609 are printed on sheets after the page order is rearranged as illustrated in FIG. 6D. The diagram illustrates a situation where a cover sheet front 610 and a cover sheet back 611 are imposed with those pages illustrated in FIG. 6D. Note that FIG. 6D illustrates a situation where the pages are imposed to leave a gap as much as the spine width, or the book block bundle thickness 606, to form the spine portion of the perfect-bound product. Since the perfect binding spine portion has been described in detail with reference to FIG. 4B, a detailed description thereof will be omitted.

FIG. 6F is a diagram illustrating an example of a case where a perfect-bound product is fabricated from the document data illustrated in FIG. 6A, with the cover portions constituted by an insert cover without print processing. The insert cover corresponds to an example of the case where cover sheets are supplied from the insert tray 111-5 described with reference to FIGS. 1 and 4.

When using an insert cover, pages generated by the document generation application 301 do not need to be assigned to the pages constituting the front and back covers. This results in the page order and composition illustrated in the diagram. Moreover, in the case of using an insert cover, the imposition processing such as illustrated in FIGS. 6B and 6D for composing the covers are not needed, and the spine portion does not need to be taken into consideration. This, however, is predicated on that the insert cover previously fabricated and loaded on the insert tray 111-5 is one appropriately prepared after due consideration of the bundle thickness of the perfect binding book block to be formed.

FIG. 6G is a diagram illustrating another example for describing details of the page order control of a cover and a book block 616 during the perfect binding processing, and the imposition processing of the cover portions. The example illustrated in the diagram demonstrates a case where the document generation application 301 generates the -2nd page and the -1st page, with a front cover 614 and a back cover 615 of the perfect-bound product pre-imposed including the spine portion.

Like FIG. 6G, FIG. 6H illustrates another example where the document generation application 301 generates the first and second pages, with a front cover 617 and a back cover 618 of the perfect-bound product pre-imposed including the spine portion. In this example, the front and back cover pages are arranged at the beginning of the document data.

There are modes where multiple page orders can be taken depending on the document generation application 301 or the perfect binding unit 109 and the control method thereof. The printing system according to the first embodiment of the present disclosure can be configured so that each of the various perfect-bound products and perfect binding cover composition patterns illustrated in FIGS. 6A to 6H can be accommodated.

### Perfect Binding Processing Timing Parallel Processing

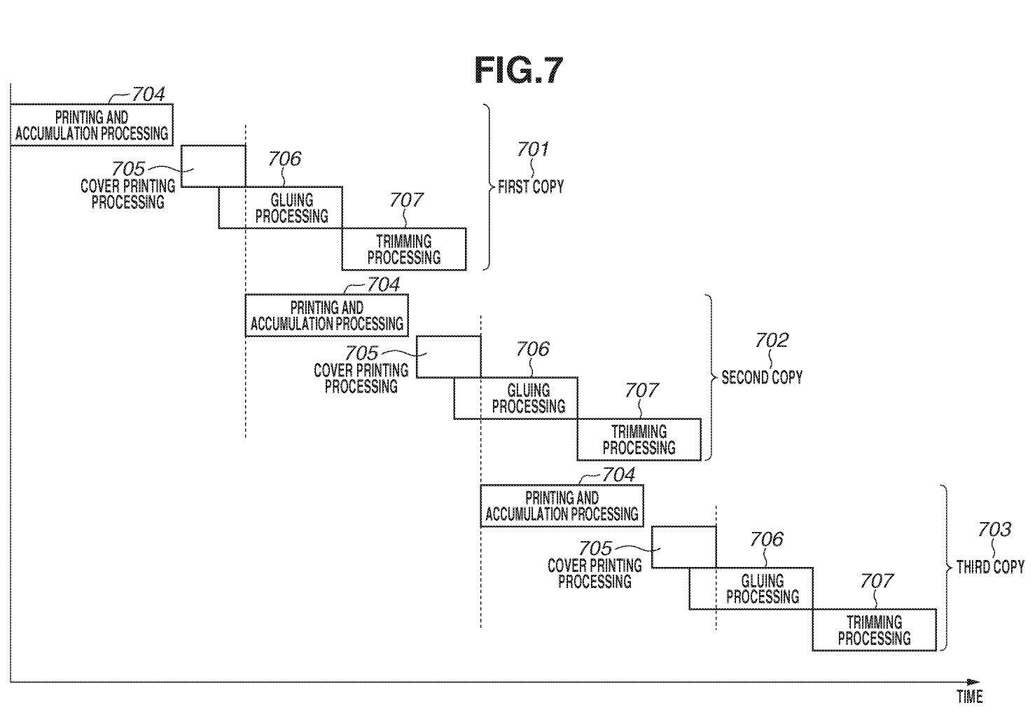

FIG. 7 is a processing timing chart when the MFP 101 generates perfect-bound products as illustrated in FIGS. 4A to 4C from various types of perfect binding document data generated by the document generation application 301, using the mechanism illustrated in FIG. 3.

Initially, printing and stacking processing 704 of sheets corresponding to the book block pages of a first copy 701 is performed.

Since the stacking processing has been described in conjunction with the description of the stacking tray 501 in FIG. 5, a detailed description thereof will be omitted.

After the completion of the stacking of the book block, cover printing processing 705 of the first copy 701 is performed. Note that this applies to the various examples illustrated in FIGS. 6A to 6H where print processing is involved. If print processing is not involved, i.e., in the case of FIG. 6F, the cover printing processing 705 corresponds to processing of conveying the preprinted cover sheet from the insert tray 111-5 to a predetermined position without print processing.

Next, the gluing unit 503 illustrated in FIG. 5 applies gluing processing 706 to the portion of the stacked book block corresponding to the spine. The folding unit 505 then processes the glued article, and the trimming unit 506 also illustrated in FIG. 5 performs trimming processing 707. The resulting product is output to the tray 112-1.

A second copy 702 and subsequent copies are processed in a manner similar to the first copy 701. Note that FIG. 7 illustrates an example of a case where the perfect binding unit 109 according to the present embodiment is configured to perform part of the processing of the second copy 702 in advance that can be performed in parallel with the processing of the first copy 701.

Specifically, the printing and stacking processing 704 of the book block of the second copy 702 can be performed in parallel while the gluing processing 706 of the first copy 701 is being performed. The reason is that the MFP 101 is configured, as illustrated in FIG. 5, so that after the gluing processing 706 is started, the stacking tray 501 is empty and the printing and stacking processing 704 of the book block of the next copy can be performed. The same applies to a third copy 703.

### Display Screen of Document Generation Application

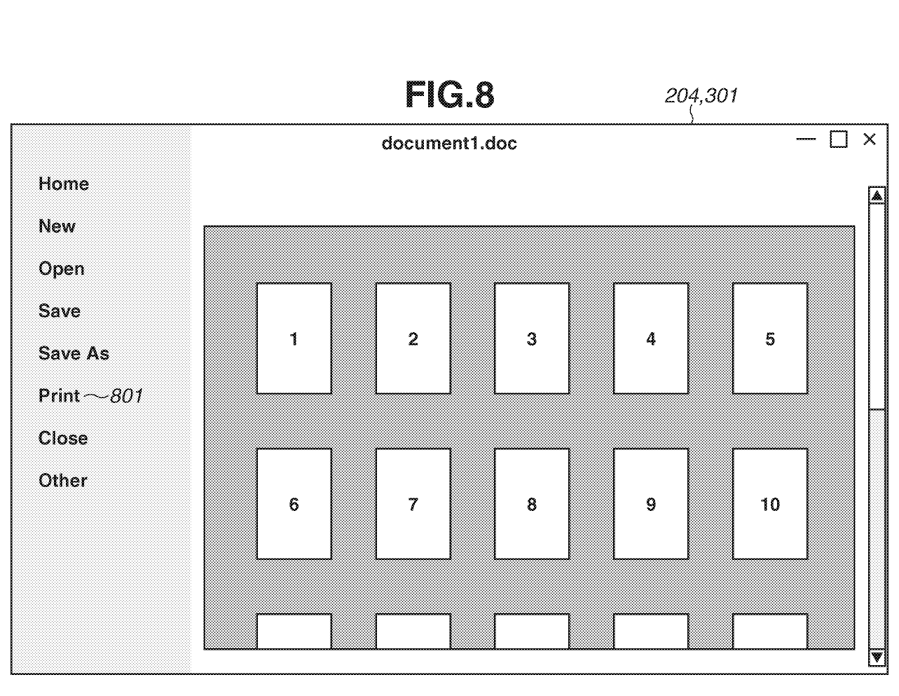

FIG. 8 illustrates a display screen of the document generation application 301 that runs on the client terminal 102 and is used when performing perfect binding print processing in the printing system according to the present embodiment. Selecting [Print] 801 starts a series of processes related to print settings about data to be printed generated by the document generation application 301 and the execution of print processing to be described below.

### Print Queue Selection Screen

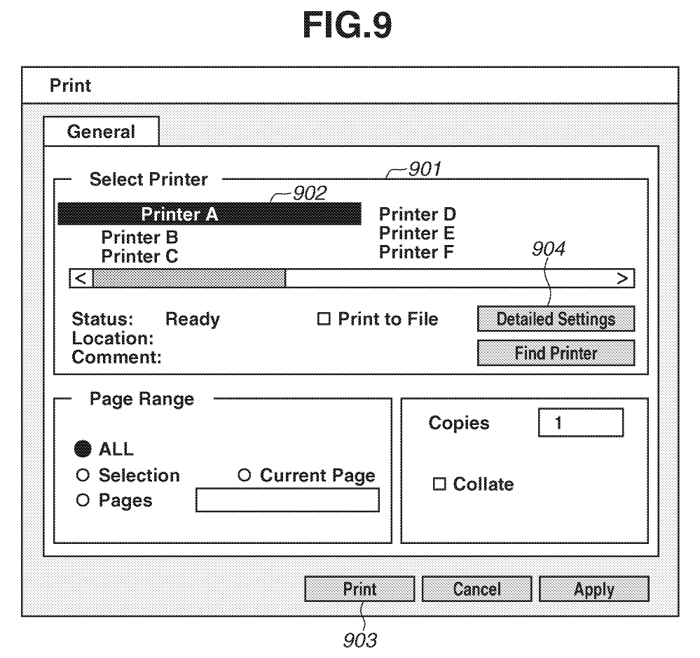

FIG. 9 illustrates an example of a print queue selection screen displayed by the operating system 304, triggered by the selection of [Print] 801 in FIG. 8.

A print queue list area 901 is an area used in selecting a print queue selectable on the client terminal 102, i.e., a printer that can perform print processing. The example illustrated in the diagram will now be described on the assumption that Printer A 902 corresponds to the MFP 101 illustrated in FIG. 1.

A [Print] button 903 is a unit to be selected when performing print processing with the printer selected in the foregoing print queue list area 901. In the example illustrated in the diagram, the print processing is performed with Printer A 902.

A [Detailed Settings] button 904, which is a detailed print setting specification unit, is intended to be selected to configure various settings to be applied during printing. When the [Detailed Settings] button is pressed, a setting screen of the print driver corresponding to the printer selected in the print queue list area 901 is displayed. In the present embodiment, the setting screen to be displayed is that of the general-purpose print driver illustrated in FIG. 3. The setting screen of the print driver displayed upon selection of the [Detailed Settings] button 904, which is the detailed print setting specification unit, is therefore one intended to select common setting items as will be described below. If vendor-specific print drivers corresponding to printers selectable in the print queue list area 901 are installed on the client terminal 102, the setting screen of the corresponding vendor-specific print driver is controlled to be displayed.

### Print Setting Screens

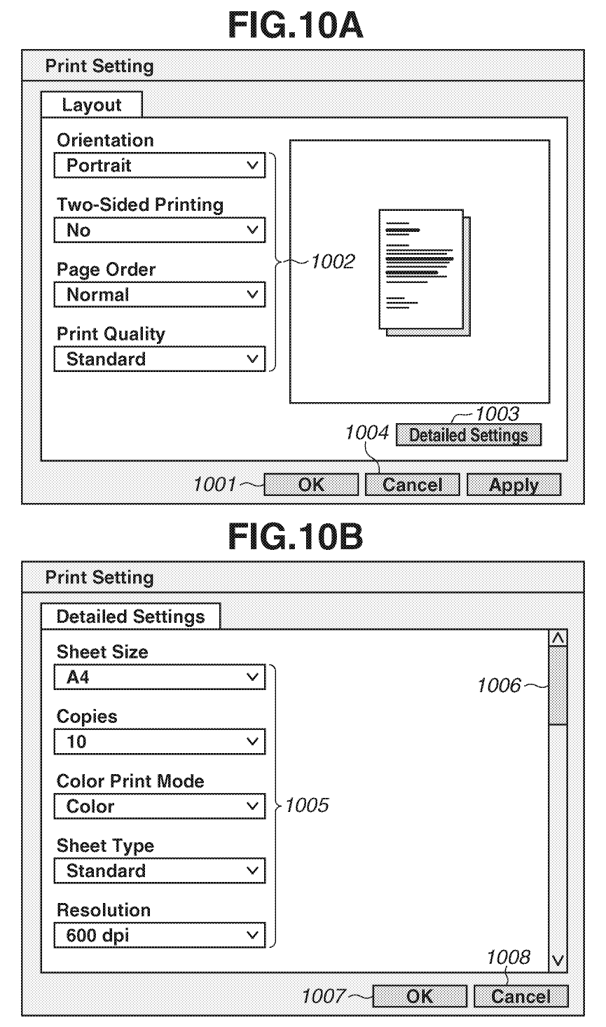

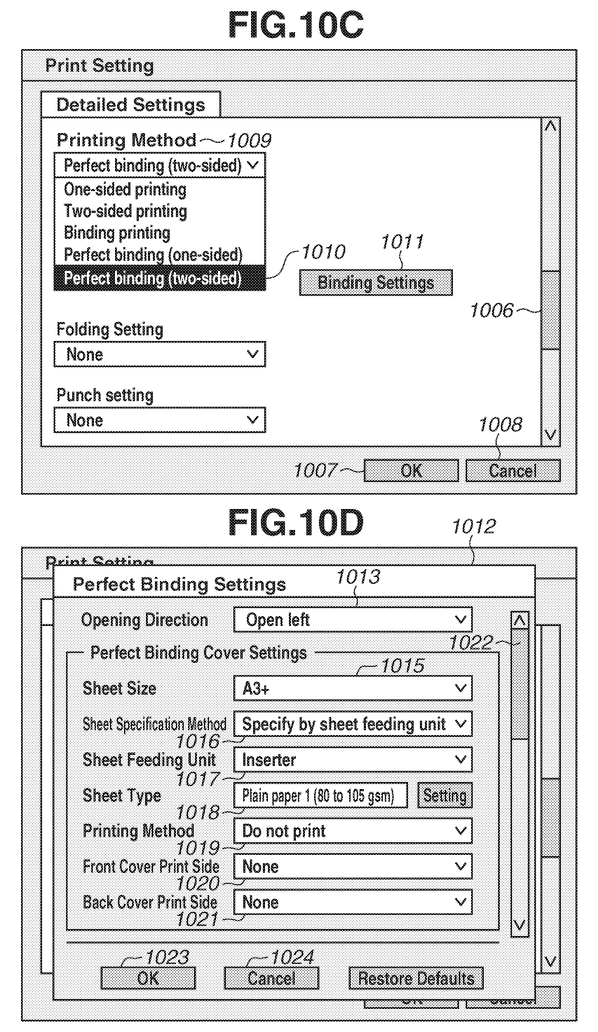

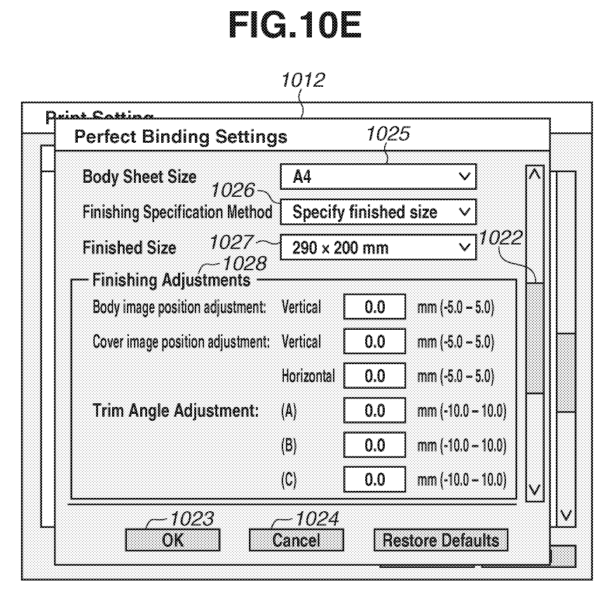

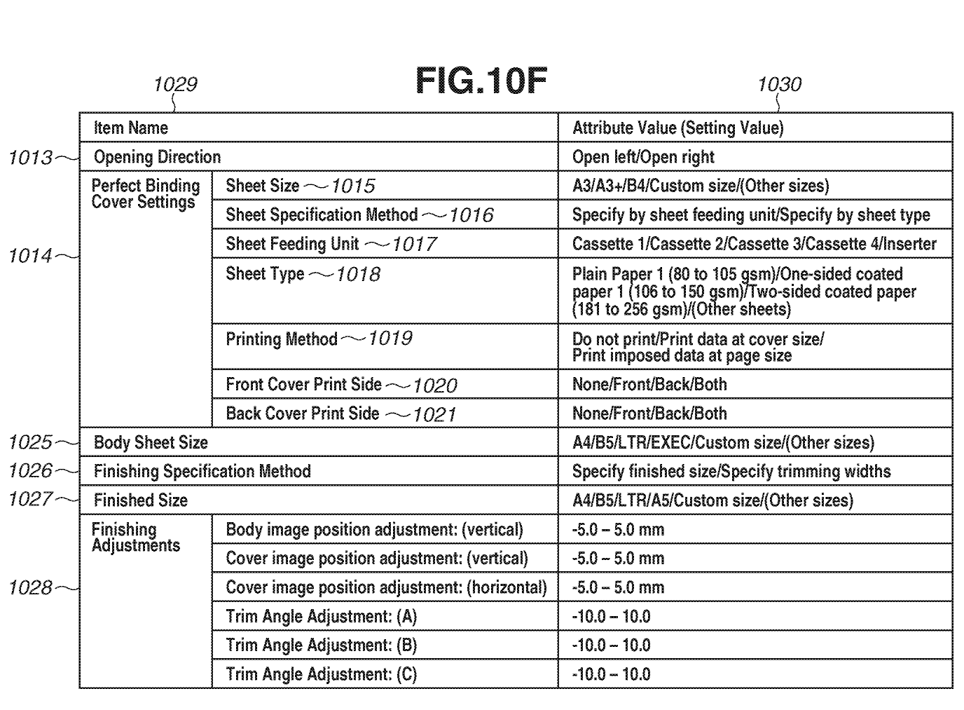

Next, print setting screens will be described with reference to FIGS. 10A to 10F.

FIG. 10A illustrates an example of a setting screen of the general-purpose print driver 302, which is displayed on the display unit 204 when the [Detailed Settings] button 904 is selected in FIG. 9. This setting screen presents general-purpose setting items 1002 for setting functions configurable using the general-purpose print driver 302. These setting items only include ones applicable to any printer. No setting units are thus provided for proprietary functions provided by printer vendors or complex functions such as the perfect binding function described in the present embodiment.

A [Detailed Settings] button 1003, which is a detailed setting selection unit, is intended to be selected when the print setting extension application 303 is used to select setting items for setting functions not provided by the general-purpose print driver 302.

An [OK] button 1001 is intended to be selected when storing the content of the setting processing by the general-purpose print driver 302 illustrated in the diagram and transitioning to the screen state of FIG. 9. A [Cancel] button 1004 is intended to be selected when discarding the content of the setting processing by the general-purpose print driver 302 illustrated in the diagram and transitioning to the screen state of FIG. 9.

FIG. 10B illustrates a selection screen of print setting items provided by the print setting extension application 303, which is an auxiliary printing program. This screen is displayed when the [Detailed Settings] button 1003 is pressed in FIG. 10A. Here, an example where various setting items 1005 are presented as illustrated in the diagram will be described. Unlike the general-purpose print setting items configurable using the general-purpose print driver 302 illustrated in FIG. 10A, setting items provided by the print setting extension application 303 are enormous in number. In the illustrated example, a scrollbar 1006 is therefore provided to display items that are unable to be fully displayed within the display area illustrated in the diagram.

An [OK] button 1007 is intended to be selected when storing the content of the setting processing by the print setting extension application 303 and transitioning to the screen state of FIG. 10A. A [Cancel] button 1008 is intended to be selected when discarding the content of the setting processing by the print setting extension application 303 illustrated in the diagram and transitioning to the screen state of FIG. 10A.

FIG. 10C illustrates a second example of the print setting item selection screen provided by the print setting extension application 303. The diagram illustrates a case where a printing method selection item 1009 is included. Selectable options of the printing method include one for the perfect binding. The example of FIG. 10C demonstrates a state where the option for perfect binding (two-sided) 1010 is selected. Selecting a [Binding Settings] button 1011 in the state illustrated in the diagram enables selection processing of more detailed setting items related to the perfect binding settings.

FIG. 10D illustrates an example of a detailed setting item selection screen 1012 of the perfect binding function, provided by the print setting extension application 303. Each of the detailed setting items for the setting functions of the perfect binding function illustrated in the diagram will now be described in more detail.

An opening direction 1013 is intended to be selected when setting the opening direction of perfect-bound products. The example illustrated in the diagram demonstrates a state where "Open left" is selected.

A perfect binding cover settings area 1014 provides various settings related to the perfect binding cover to be applied when fabricating perfect-bound products. The settings of perfect-bound products, and the cover settings in particular, need complex settings as illustrated in FIGS. 4, 5, and 6A to 6H. These setting items are therefore difficult for the foregoing general-purpose print driver 302 to provide. As described in the present embodiment, the setting items of the perfect binding cover function are therefore provided by the print setting extension application 303. Each setting item included in the perfect binding cover settings area 1014 will now be described.

A sheet size 1015 is used to set the sheet size of the perfect binding cover. As will be described below with reference to FIG. 10E, the present embodiment deals with an example where "A4" is selected for a body sheet size 1025 that is the sheet size of the book block. A sheet size capable of wrapping the book block therefore needs to be selected as the sheet size 1015 of the perfect binding cover. The example illustrated in the diagram thus demonstrates a state where "A3+" size is selected. Note that if the perfect binging processing settings are predicated on trimming processing, the cover size does not need to be the exact size obtained by adding the bundle thickness to the sheet size of the book block. Even with a somewhat different size, the desired perfect-bound product can be obtained by evenly trimming the article during trimming processing.

A sheet specification method 1016 is a unit intended to specify the method for selecting sheets to be used as perfect binding covers. The example illustrated in the diagram demonstrates a case where the "Specify by sheet feeding unit" is selected. In this example, the insert tray 111-5 is selected at a sheet feeding unit 1017.

A sheet type 1018 is a unit for specifying the type of sheets to be used as perfect binding covers. The example illustrated in the diagram demonstrates a case where "Plain paper 1 (80 to 105 gsm)" is selected.

A printing method 1019 is a unit for specifying the print side and printing method of the perfect binding cover. The example illustrated in the diagram demonstrates a case where "Do not print" is selected.

This option is intended to use preprinted cover sheets from the insert tray 111-5 as perfect binding covers during the fabrication of perfect bound products.

A front cover print side 1020 and a back cover print side 1021 are both selection units for configuring perfect binding cover settings in a case where image formation processing is involved. Since the example illustrated in the diagram demonstrates settings to use preprinted cover sheets inserted from the insert tray 111-5, "None" is selected for both the settings so that no print processing is performed on the front and back covers. The front cover print side 1020 and the back side print side 1021 are grayed out to disable selection in response to "Do not print" in the printing method 1019.

There are other setting items related to perfect binding than those illustrated in the diagram. A scrollbar 1022 is thus provided to enable further selection of other setting items. The content of such setting items will be described below.

An [OK] button 1023 is intended to be selected when storing the content of the setting processing performed using the detailed setting item selection screen 1012 of the perfect binding function and transitioning to the screen state of FIG. 10C. A [Cancel] button 1024 is intended to be selected when discarding the content of the setting processing on the detailed setting item selection screen 1012 of the perfect binding function illustrated in the diagram and transitioning to the screen state of FIG. 10C.

FIG. 10E is a diagram for describing a second example of the detailed setting item selection screen 1012 for the setting functions of the perfect binding function provided by the print setting extension application 303. Each of the detailed setting items of the perfect binding function illustrated in the diagram will now be described in more detail.

The body sheet size 1025 is an item for setting the size of sheets to be used for a perfect binding book block. In the example illustrated in the diagram, "A4" is selected.

A finishing specification method 1026 is an item for specifying the trimming processing on perfect-bound products. The example illustrated in the diagram demonstrates a case where the amount of trimming by the trimming processing is consequently selected by specifying the finished size.

A finished size 1027 is an item for specifying the size after the application of the trimming processing. In the example of the diagram, a finished size with a height and width of "290 mm × 200 mm" is specified.

Since the size of the perfect binding book block is "A4", i.e., 297 mm in height and 210 mm in width, this example demonstrates a case where the finished size is specified so that trimming processing of 7 mm in the height direction and 10 mmm in the width direction is performed.

A finishing adjustments 1028 is an area for making various fine adjustments when fabricating a perfect-bound product. Specifically, the print position relative to the book block, the print position relative to the cover, angular adjustments during the trimming processing, and the like can be specified. A detailed description of these adjustment items will be omitted. Since the perfect binding function needs complex setting items, the setting units need to be provided not by the general-purpose print driver 302 but by the print setting extension application 303 as described above.

FIG. 10F is a chart illustrating the content and ranges of possible setting values of the respective perfect binding-related setting items described above with reference to FIGS. 10D and 10E. While FIGS. 10D and 10E illustrate an example where certain values are selected among the possible setting values of the respective setting items, the setting items can in fact take values illustrated in FIG. 10F. The print setting extension application 303 according to the present embodiment controls detection and resolution of conflicting states of setting values as appropriate based on the selected setting values.

### Perfect Binding Setting/Execution Processing

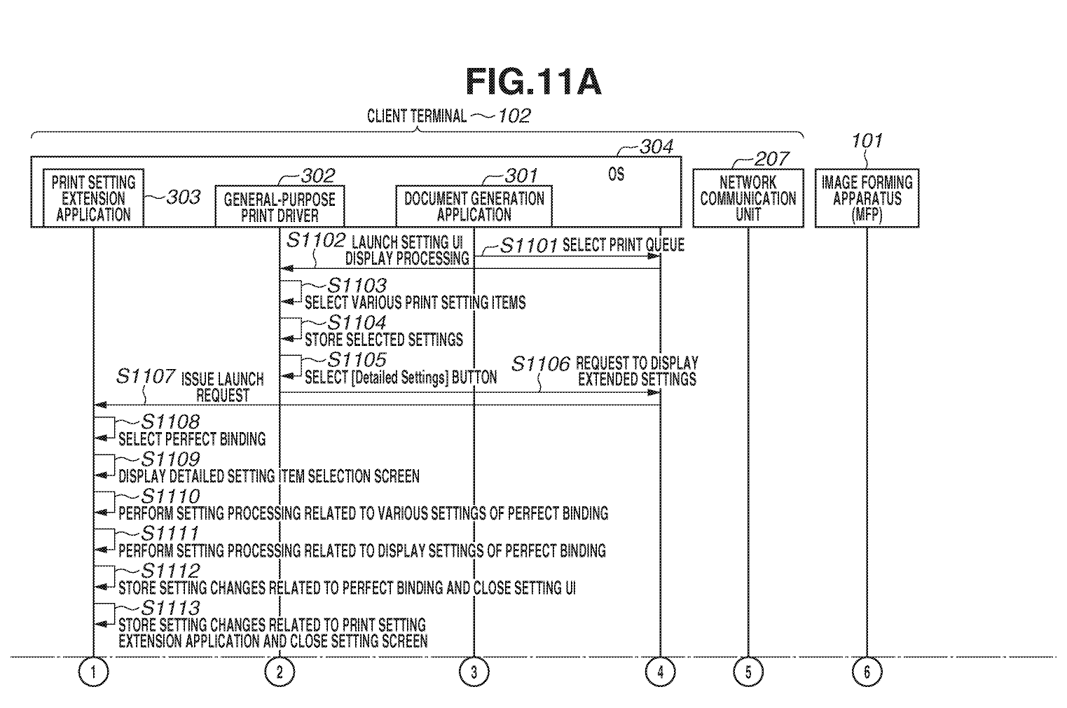

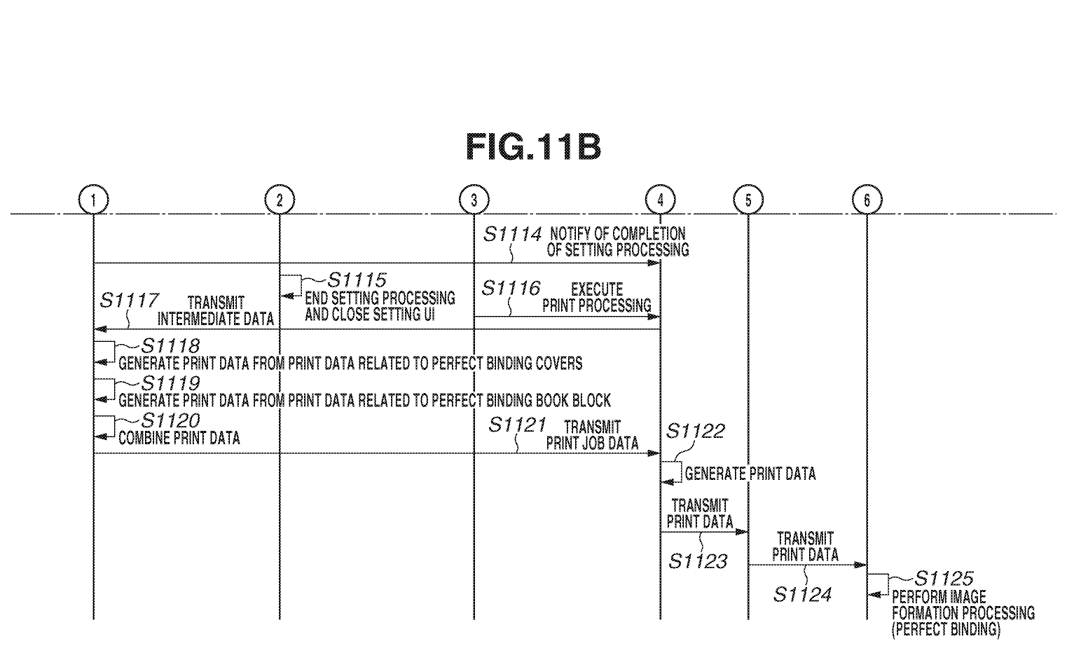

FIGS. 11A and 11B are a sequence diagram for mainly describing operations within the client terminal 102 during execution of the perfect binding setting processing and during execution of the perfect binding processing. The operations illustrated in this sequence diagram are implemented by the CPU 202 executing various programs illustrated in FIG. 3 and controlling the modules illustrated in FIG. 2.

In step S1101, the document generation application 301 selects a print queue. This print queue selection processing corresponds to processing where [Print] 801 illustrated in FIG. 8 is selected to cause the operating system 304 to implement the print queue selection units illustrated in FIG. 9. With an appropriate print queue selected in step S1101, the detailed print setting specification section 904 illustrated in FIG. 9 is then selected.

In step S1102, the operating system 304 launches setting UI display processing of the general-purpose print driver 302, whereby the setting screen of FIG. 10A is presented.

In step S1103, processing for selecting various types of print setting items provided by the general-purpose print driver 302 is performed.

In step S1104, the general-purpose print driver 302 stores into the storage unit 206 settings selected by the setting selection processing of the general-purpose setting items 1002 presented as illustrated in FIG. 10A.

In step S1105, the [Detailed Settings] button 1003, which is the detailed setting selection unit, on the setting UI of the general-purpose print driver 302 of FIG. 10A is selected. Here, the print setting units provided by the print setting extension application 303 need to be displayed on the display unit 204.

In step S1106, the general-purpose print driver 302 requests the operating system 304 to display extended settings.

In step S1107, the operating system 304 issues a launch request to the print setting extension application 303. In response, the print setting extension application 303 displays an extension setting display setting UI on the display unit 204.

In step S1108, the print setting extension application 303 accepts selection of the perfect binding from the printing method selection item 1009 (see FIG. 10C).

In step S1109, the print setting extension application 303 displays the detailed setting item selection screen 1012 of the perfect binding function on the display unit 204 (see FIG. 10D). This detailed setting item selection screen 1012 of the perfect binding function is also provided by the print setting extension application 303, not by the general-purpose print driver 302.

In steps S1110 and S1111, the print setting extension application 303 performs setting processing related to various perfect binding settings and perfect binding cover settings, respectively. Specifically, the setting processing corresponds to processing for performing the various setting operations illustrated in FIGS. 10D and 10E. As illustrated in FIG. 10D, for the perfect binding, a size different from that of the book block needs to be specified for the cover, and there are also various specification methods for the cover. This complicates the specification of functions, making it difficult for the general-purpose print driver 302 to provide the setting units. In the present embodiment, the print setting extension application 303 is thus configured to be capable of configuring such specifications.

In step S1112, the [OK] button 1023 in FIG. 10D or 10E is selected, and the print setting extension application 303 stores setting changes related to the perfect binding and closes the setting UI. This corresponds to the operation of transitioning to the state of FIG. 10C.

In step S1113, the print setting extension application 303 stores setting changes related thereto, and closes the setting screen. This corresponds the operation of selecting the [OK] button 1007 in FIGS. 10B or 10C and transitioning to the state of FIG. 10A. All necessary print settings by the print setting extension application 303 are thereby completed.

In step S1114, the print setting extension application 303 notifies the operating system 304 of the completion of its setting processing.

In step S1115, the setting processing by the general-purpose print driver 302 also ends, and the setting UI is closed. This corresponds to the operation of selecting the [OK] button 1001 in FIG. 10A and transitioning to the state of FIG. 9.

FIG. 11 illustrates a state where the document generation application 301 executes print processing in step S1116. In other words, this corresponds to the processing when the [Print] button 903 is selected in the state of FIG. 9.

In the following steps, actual print processing is performed based on the settings configured up to step S1116. In other words, in the example described in the present embodiment, a print job with perfect binding settings is executed. Specifically, perfect-bound product fabrication processing based on the settings configured in FIGS. 10D and 10E is performed.

In the example according to the present embodiment, the execution of a print job including print settings provided by the print setting extension application 303 is instructed. Specifically, the execution of a print job including the perfect binding settings configured by the print setting extension application 303 is instructed. The processing for generating print job data including the settings configured by the print setting extension application 303 is unable to be implemented through the generation processing of print job data using the capabilities of the general-purpose print driver 302 alone.

In step S1117, the operating system 304 issues the print processing execution instruction accepted in step S1116 to the print setting extension application 303. Specifically, the operating system 304 transmits data to be printed generated by the document generation application 301 to the print setting extension application 303 as intermediate data.

Receiving the intermediate data, the print setting extension application 303 performs conversion processing from the intermediate data into print data based on the content of the print settings stored. In the example according to the present embodiment, the execution of a print job including perfect binding settings is instructed. The print setting extension application 303 thus performs intermediate data generation processing based on the perfect binding-related settings included in the stored print settings.

In step S1118, the print setting extension application 303 generates print data related to the perfect binding cover from the intermedia data.

In step S1119, the print setting extension application 303 generates print data related to the perfect binding book block from the intermedia data. The print setting extension application 303 according to the present embodiment is configured so that the print data generation processing in steps S1118 and 1119 is appropriately performed based on the perfect binding settings illustrated in FIGS. 10A to 10F. Examples of the perfect binding settings include various settings related to the perfect binding cover

illustrated in FIGS. 6A to 6H, or more specifically, the page order illustrated in FIGS. 6B, 6D, 6G, and 6H, the imposition settings illustrated in FIGS. 6C and 6E, and the control of insert covers (FIG. 6F).

In step S1120, the print setting extension application 303 combines the print data converted in steps S1118 and S1119 to generate a single piece of print job data.

In step S1121, the print setting extension application 303 transmits the print job data to the operating system 304. This corresponds to the response to the instruction issued in step S1117.

In step S1122, the operating system 304 generates print data. Specifically, the operating system 304 attaches print setting information to the print job data accepted in step S1121, thereby generating data of format processible by the MFP 101.

In step S1123, the operating system 304 transmits the print data generated in step S1122 to the network communication unit 207.

In step S1124, the network communication unit 207 further transmits the print data to the MFP 101.

In step S1125, the MFP 101 performs image formation processing based on the received job data (print data). In the case of the present embodiment, image formation processing related to the fabrication of prefect-bound products is performed. The specific content of the image formation processing has been described with reference to FIGS. 4A to 5. A detailed description thereof will thus be omitted.

The selection content and order of the foregoing settings are merely exemplary, and the selection order of the settings is not limited to that illustrated in the diagram. If some of the setting operations are not selected, the corresponding setting steps are also omitted.

### Print Setting Processing: Client Terminal

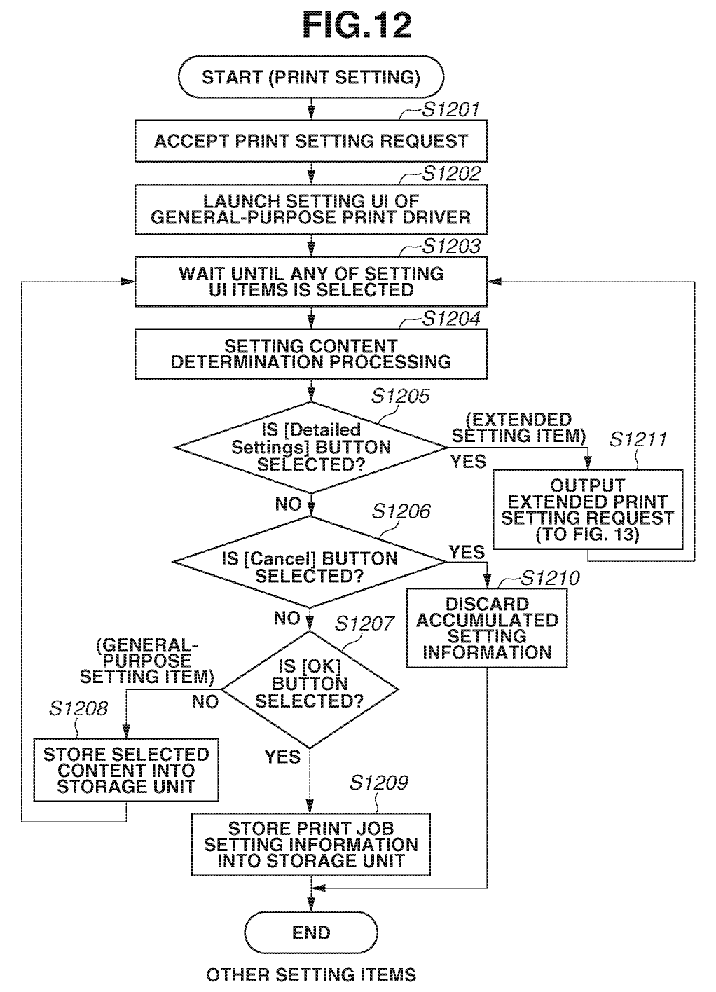

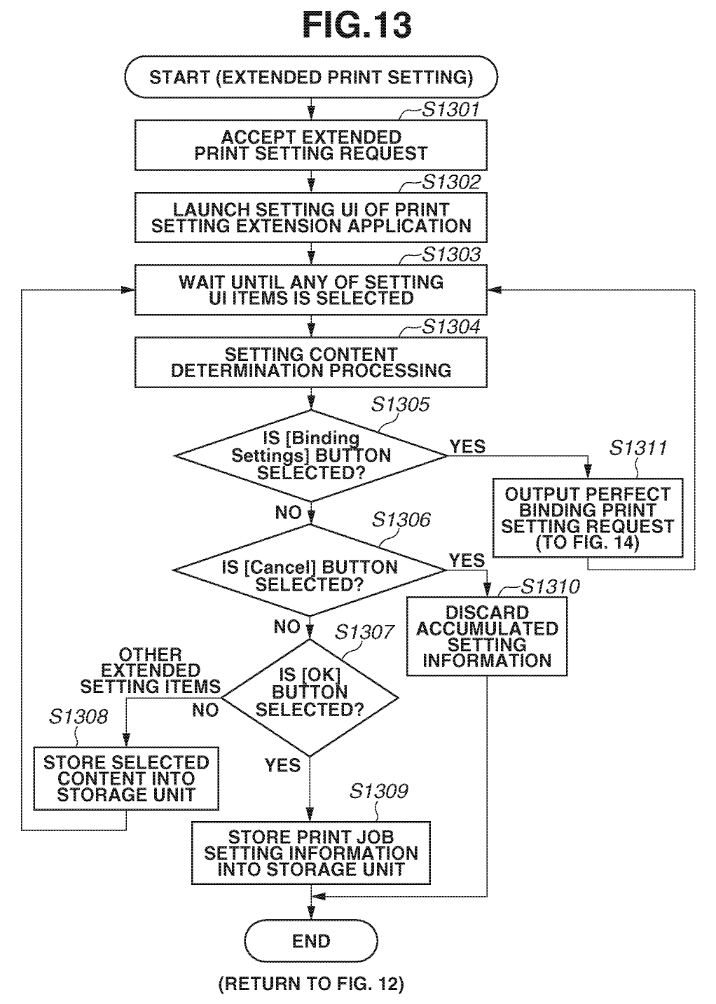

FIG. 12 is a flowchart for describing the operation of the client terminal 102 related to print setting processing execution processing. The operation illustrated in the flowchart is implemented by the CPU 202 calling the general-purpose print driver 302 illustrated in FIG. 3 and executing the general-purpose print driver 302.

In step S1201, the CPU 202 accepts a print setting request.

In step S1202, the CPU 202 launches the setting UI of the general-purpose print driver 302. This corresponds to processing of detecting that the [Print] button 903 illustrated in FIG. 9 is selected and displaying the setting screen illustrated in FIG. 10A on the display unit 204.

In step S1203, the CPU 202 waits until the printing system enters a state of accepting the user's setting operation and any of the setting units provided by the general-purpose print drive 302 is selected.

If any of the setting units provided by the general-purpose print driver 302 is selected, the processing proceeds to step S1204.

In step S1204, the CPU 202 performs determination processing of the selected setting content.

In step S1205, the CPU 202 determines whether the setting content determined in step S1204 is provided by the print setting extension application 303.

If the [Detailed Settings] button 1003 is determined to be selected (YES in step S1205), the processing proceeds to step S1211. In step S1211, the CPU 202 performs display processing of print setting items provided by the print setting extension application 303. This corresponds to the processing of displaying the setting screen illustrated in FIG. 10B. Details of the processing in step S1211 will be described below with reference to FIG. 13.

If, in step S1205, the [Detailed Settings] button 1003 is determined to not be selected (NO in step S1205), the processing proceeds to step S1206.

In step S1206, the CPU 202 determines whether the [Cancel] button 1004 is selected among the setting units provided by the general-purpose print driver 302.

If the [Cancel] button 1004 is determined to be selected (YES in step S1206), the processing proceeds to step S1210.

In step S1210, the CPU 202 discards the setting information that is stored in the storage unit 206 and accumulated until the execution of the foregoing procedure. The processing illustrated in the flowchart ends.

On the other hand, if the [Cancel] button 1004 is determined to not be selected (NO in step S1206), the processing proceeds to step S1207.

In step S1207, the CPU 202 determines whether the setting content determined in step S1204 is the selection of the [OK] button 1001 provided by the general-purpose print driver 302.

If the [OK] button 1001 is determined to be selected (YES in step S1207), the processing proceeds to step S1209.

In step S1209, the CPU 202 stores the settings that are configured so far and stored in the storage unit 206 as print job setting information into the storage unit 206. The processing illustrated in this flowchart ends.

On the other hand, if the [OK] button 1001 is determined to not be selected (NO in step S1207), the processing proceeds to step S1208.

Step S1208 corresponds to cases where the setting content determined in step S1204 is not the selection of the foregoing [Detailed Settings] button 1003, [Cancel] button 1004, or [OK] button 1001. This means selection of various setting items provided by the general-purpose print driver 302 illustrated as an example in FIG. 10A. In such a case, the processing proceeds to step S1208. In step S1208, the CPU 202 stores the selection content of the setting item provided by the general-purpose print driver 302 into the storage unit 206. The processing returns to step S1203 and the CPU 202 transitions to the setting input waiting state again.

### Print Setting Processing: Extension Application Client Terminal

FIG. 13 is a flowchart for describing the print setting processing-related operation of the client terminal 102 according to the present embodiment. The operation illustrated in this flowchart is implemented by the CPU 202 calling the print setting extension application 303 illustrated in FIG. 3 and executing the print setting extension application 303.

In step S1301, the CPU 202 accepts an extended print setting request.

In step S1302, the CPU 202 launches the setting UI of the print setting extension application 303. This corresponds to the processing of detecting that the [Detailed Settings] button 1003 illustrated in FIG. 10A is selected, and displaying the extended setting screen illustrated in FIG. 10B on the display unit 204.

In step S1303, the CPU 202 waits until the printing system enters the state of accepting the user's setting operation and any of the setting units provided by the print setting extension application 303 is selected.

If any of the setting units provided by the print setting extension application 303 is selected, the processing proceeds to step S1304. In step S1304, the CPU 202 performs determination processing of the selected setting content.

In step S1305, the CPU 202 determines whether the setting content determined in step S1304 is selection setting processing of the perfect binding settings provided by the print setting extension application 303, i.e., selection processing of the [Binding Settings] button 1011 illustrated in FIG. 10C.

If the setting content is the selection setting processing of the perfect binding settings (YES in step S1305), the processing proceeds to step S1311. In step S1311, the CPU 202 performs display processing of the detailed setting item selection screen 1012

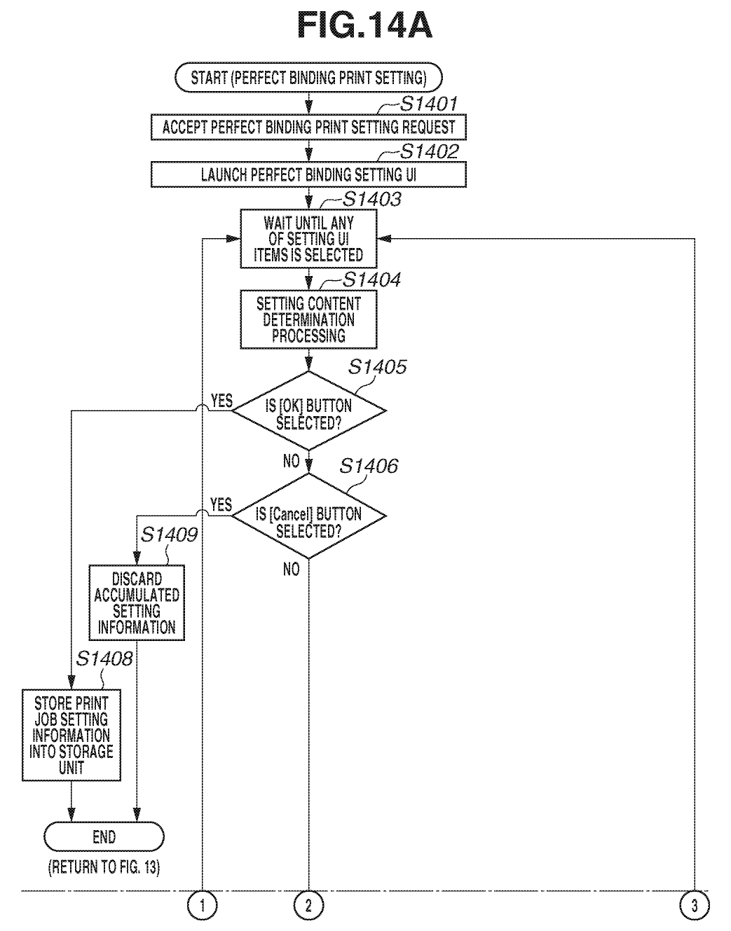

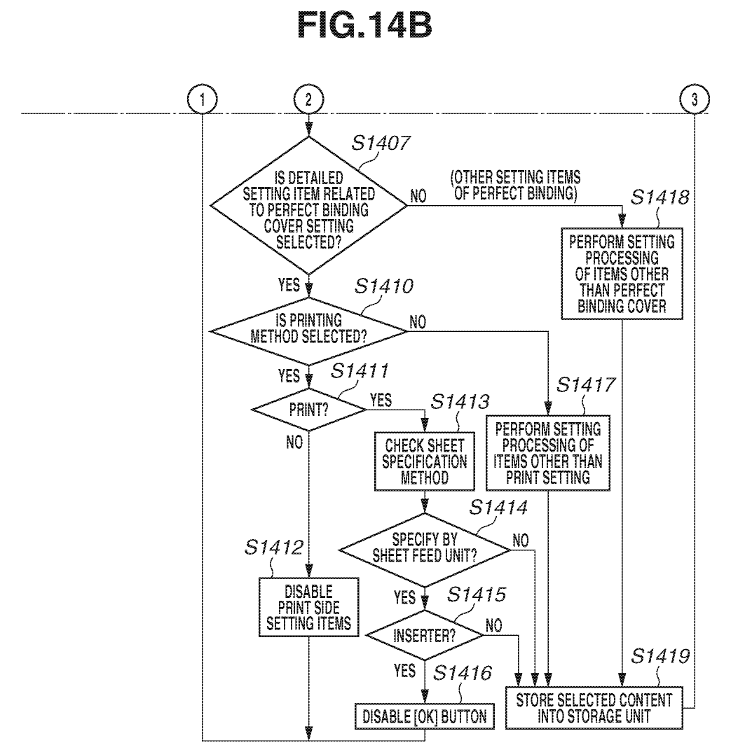

of the perfect binding function, provided by the print setting extension application 303. This corresponds to the processing of displaying the setting screen illustrated in FIG. 10D. Details of the processing in step S1311 will be described below with reference to FIGS. 14A and 14B.

If the setting content is not the selection setting processing of the perfect binding settings (NO in step S1305), the processing proceeds to step S1306.

In step S1306, the CPU 202 determines whether the [Cancel] button 1008 is selected among the setting items provided by the print setting extension application 303.

If the [Cancel] button 1008 is determined to be selected (YES in step S1306), the processing proceeds to step S1310.

In step S1310, the CPU 202 discards the setting information that is stored in the storage unit 206 and accumulated until the execution of the foregoing procedure. The processing illustrated in this flowchart ends.

On the other hand, if the [Cancel] button 1008 is determined to not be selected (NO in step S1306), the processing proceeds to step S1307.

In step S1307, the CPU 202 determines whether the setting content determined in step S1304 is the selection of the [OK] button 1007 provided by the print setting extension application 303.

If the [OK] button 1007 is determined to be selected (YES in step S1307), the processing proceeds to step S1309.

In step S1309, the CPU 202 stores the settings that are the content of setting performed so far and are stored in the storage unit 206 into the storage unit 206 as print job setting information. The processing illustrated in this flowchart ends.

On the other hand, the case where the [OK] button 1007 is not selected (NO in step S1307) corresponds to situations where neither of the [Cancel] button 1008 and [OK] button 1007 on the detailed setting item selection screen 1012 of the perfect binding function is selected. This means selection of various setting items provided by the print setting extension application 303 illustrated as an example in FIG. 10B. In such a case, the processing proceeds to step S1308. In step S1308, the CPU 202 stores the content that is selected as a setting item provided by the print setting extension application 303 into the storage unit 204. The processing returns to step S1303 and the CPU 202 transitions to the setting input waiting state again.

### Perfect Binding Print Setting Processing Client Terminal

FIGS. 14A and 14B are a flowchart for describing the operation of the client terminal 102 related to the perfect binding print setting processing. The operation illustrated in the flowchart is implemented by the CPU 202 calling the print setting extension application 303 illustrated in FIG. 3 and executing the print setting extension application 303.

In step S1401, the CPU 202 accepts a perfect binding print setting request for the print setting extension application 303.

In step S1402, the CPU 202 launches the perfect binding setting UI of the print setting extension application 303.

This corresponds to the processing of detecting the selection of the [Binding Settings] button 1011 illustrated in FIG. 10C and displaying the detailed setting item selection screen 1012 of the perfect binding function illustrated in FIG. 10D on the display unit 204.

In step S1403, the CPU 202 waits until the printing system enters the state of accepting the user's setting operations and any of the perfect print setting units provided by the print setting extension application 303 is selected.

If any of the perfect binding setting units provided by the print setting extension application 303 is selected, the processing proceeds to step S1404.

In step S1404, the CPU 202 performs processing for determining the selected setting content.

In step S1405, the CPU 202 determines whether the setting content determined in step S1404 is the selection of the [OK] button 1023 on the detailed setting item selection screen 1012 of the perfect binding setting provided by the print setting extension application 303.

If the [OK] button 1023 is determined to be selected (YES in step S1405), the processing proceeds to step S1408.

In step S1408, the CPU 202 stores the settings that are the content of setting performed so far and are stored in the storage unit 206 into the storage unit 206 as print job setting information. The processing illustrated in this flowchart ends.

If the [OK] button 1023 is determined to not be selected (NO in step S1405), the processing proceeds to step S1406.

In step S1406, the CPU 202 determines whether the [Cancel] button 1024 is selected on the detailed setting item selection screen 1012 of the perfect binding setting provided by the print setting extension application 303.

If the [Cancel] button 1024 is determined to be selected (YES in step S1405), the processing proceeds to step S1409.

In step S1409, the CPU 202 discards the setting information that is stored in the storage unit 206 and accumulated until the execution of the foregoing procedure. The processing illustrated in this processing flowchart ends.

If the [Cancel] button 1024 is determined to not be selected (NO in step S1405), the processing proceeds to step S1407.

In step S1407, the CPU 202 determines whether the setting content determined in step S1404 relates to the perfect binding cover settings on the detailed setting item selection screen 1012 of the perfect binding setting provided by the print setting extension application 303. In other words, the CPU 202 determines whether the setting content is the selection processing of a setting item belonging to the perfect binding cover settings area 1014 illustrated in FIG. 10D.

If the setting content does not relate to the perfect binding cover settings (NO in step S1407), the processing proceeds to step S1418.

In step S1418, the CPU 202 performs processing for configuring setting items other than the prefect binding cover settings, provided by the detailed setting item selection screen 1012 of the perfect binding function provided by the print setting extension application 303. Specifically, among various setting items illustrated in FIGS. 10D and 10E, the CPU 202 performs processing for setting the items other than those in the perfect binding cover settings area 1014. The processing then proceeds to step S1419.

If the setting content relates to the perfect binding cover settings (YES in step S1407), the processing proceeds to step S1410.

In step S1410, the CPU 202 determines whether the printing method 1019 is selected among the perfect binding cover setting items.

If the setting content does not relate to the perfect binding cover settings (NO in step S1407), the processing proceeds to step S1417.

In step S1417, the CPU 202 performs processing for setting items other than the printing method 1019 among the setting items included in the perfect binding cover settings area 1014. The processing proceeds to step S1419.

If the printing method 1019 is selected (YES in step S1410), the processing proceeds to step S1411.

In step S1411, the CPU 202 determines whether the printing method 1019 for the perfect binding cover is set to "print".

If a cover to not be printed is selected as the setting of the perfect binding cover (NO in step S1411), the processing proceeds to step S1412. Specifically, the case where a cover to not be printed is selected corresponds to the setting to use an insert as the perfect binding cover as illustrated in FIGS. 6F and 10D.

In such a case, among the cover-related setting items included in the perfect binding cover settings area 1014, the front cover print side 1020 and the back cover print side 1021 are not needed.

In step S1412, the CPU 202 disables these setting items. FIG. 10D illustrates the state where the setting items are disabled. The processing then returns to step S1403.

If, in step S1411, the cover is selected to be printed (YES in step S1411), the processing proceeds to step S1413.

In step S1413, the CPU 202 checks the sheet specification method 1016. The sheet specification method 1016 is as illustrated in FIG. 10D.

In step S1414, the CPU 202 determines whether a "Specify by sheet feeding unit" mode is selected as the sheet specification method 1016.

If the "Specify by sheet feeding unit" mode is selected (YES in step S1414), the processing proceeds to step S1415.

In step S1415, the CPU 202 determines whether the selected sheet feeding unit 1017 is an "inserter", i.e., the insert tray 111-5 is specified.

The case where the inserter is specified (YES in step S1415) corresponds to the following situation. If the inserter is specified as the tray that feeds sheets to be used even in the presence of the setting to print the perfect binding cover, the printing is unable to be performed. If such a setting is made, it means a situation where the print settings conflict with each other and the product fabrication processing based on the settings is unable to be performed.

There are various methods for presenting conflict information in the event such setting conflict. As an example, the present embodiment demonstrates an example of the printing system where the processing proceeds to step S1416 to disable the [OK] button 1023.

The MFP 101 illustrated in FIG. 1 is configured so that if the inserter is not specified (NO in step S1415), the selected tray can feed printable sheets. In such a case, the processing proceeds to step S1419 since the [OK] button 1023 does not need to be disabled.

After the completion of the processing of steps S1414, S1415, S1417, or S1418, the processing proceeds to step S1419. In step S1419, the CPU 202 performs the selected setting processing. The processing then returns to step S1403 and the CPU 202 transitions to the input waiting state again.

As described above, perfect binding covers need to be systematically provided such that a large number of complex items are associated with each other. It is therefore difficult for the general-purpose print driver 302, which is a general-purpose setting unit, to provide the setting units and exercise control based on the set information. In the present embodiment, the print setting extension application 303 is therefore used to enable provision of the printing system configured to implement such objectives.

### SECOND EMBODIMENT

The first embodiment has described that, since there are various forms of perfect binding covers, the cover forms need to be specified using a plurality of perfect binding cover settings of the print setting extension application 303 to control the fabrication form of perfect-bound products.

A second embodiment describes an example of a case with even more complex forms of perfect binding covers, and is directed to enabling control of product generation by configuring such settings using the print setting extension application 303 like the first embodiment.

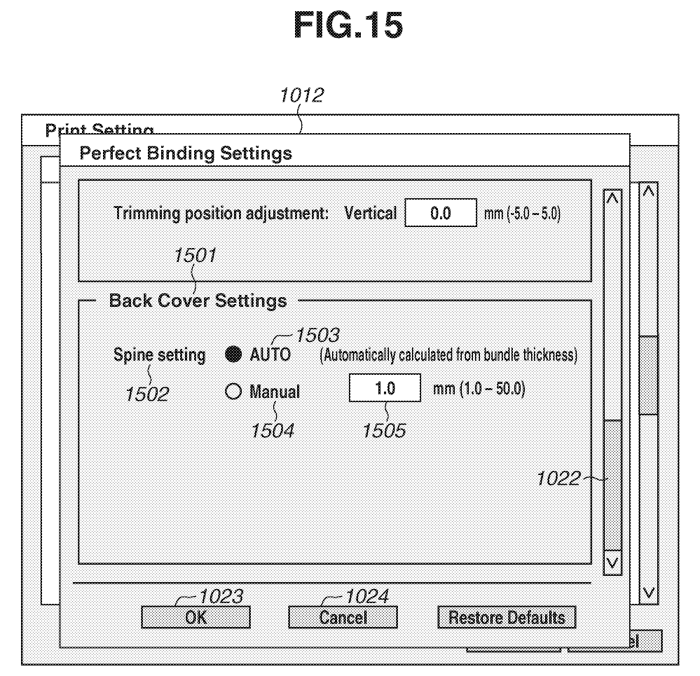

FIG. 15 illustrates an example of a spine setting screen of a perfect binding function provided by a print setting extension application 303 according to the second embodiment. The setting screen is displayed along with the setting items illustrated in FIGS. 10D, 10E, and the like according to the first embodiment. In the example illustrated in FIG. 15, the setting screen is configured so that the setting locations of predetermined items can be selected using a scrollbar 1022.

A spine settings 1501 includes various setting items to be described below, and is provided by the print setting extension application 303 as such setting units in the manner illustrated in the diagram.

A spine width setting 1502 is a setting item for specifying the width of the portion of the cover corresponding to the spine width when constituting a perfect-bound product. Specifically, the spine width setting 1502 is a setting for specifying the amount (width) of the spine portion 408 lying between the front cover portion 406 and the back cover portion 407 of the perfect binding cover sheet 405 illustrated in FIG. 4B. To fabricate a perfect-bound product of correct form, the specified amount is desirably the

same as the thickness 402 of stacked sheets. However, the thickness 402 of the stacked sheets varies depending on factors such as the amount of sheets to be stacked and the type of sheets used, and is typically difficult to accurately determine by measurement in advance.

In the printing system according to the present embodiment, the print setting extension application 303 is thus provided so that the spine width setting 1502 illustrated in the diagram can be controlled for flexible setting changes.

An auto 1503 is a setting unit to be selected when this printing system automatically determines the width amount (width) of the spine portion 408 of the prefect binding cover sheet 405 from other print job conditions. This option is used when the printing system executing a print job automatically calculates the spine width amount based on various conditions of the perfect-bound product fabrication job set by a general-purpose print driver 302 and the print setting extension application 303, and determines and applies setting values. Specifically, the thickness of the book block in the stacked state is calculated from factors such as the number of sheets to be stacked as the book block, the type of sheets used, and the thickness per sheet of each sheet type.

Unlike the auto 1503, a manual 1504 is a setting unit to be used when the user of this printing system numerically specifies the width amount (width) of the spine portion 408 of the perfect bonding cover sheet 405. This option is mostly used in cases such as when the user determines the thickness 402 of the stacked sheets from the number of pages of the product to be fabricated and the sheet specifications, and inputs the thickness 402. Another well-known way of operation is to observe the finished state after the execution of the perfect-bound product fabrication processing, numerically specify the width of the spine portion 408 for fine adjustment, and fabricate a product again.

A thickness numerical value input area 1505 is a field used to input the width amount of the spine portion 408 when the manual 1504 is selected.

Perfect-bound products with desired book block and spine sizes and widths can be fabricated by inputting a correct and appropriate spine width setting 1502 in the foregoing spine cover settings 1501 using the print setting extension application 303.

### THIRD EMBODIMENT

The first embodiment has dealt with the case where the print setting extension application 303 provides all the setting units for the perfect binding settings and perfect binding cover settings. However, as illustrated in FIG. 10F, perfect binding-related setting items are wide-ranging and closely related to each of the perfect binding cover settings.

A third embodiment describes a configuration where, instead of the print setting extension application 303 configuring all of the perfect binding and perfect binding cover setting items and setting values, the MFP 101 configures some or all of such settings.

The printing system according to the present embodiment demonstrates an example where the print setting extension application 303 here can specify only the execution of perfect binding, and all the other processing for configuring the perfect binding and perfect binding cover settings is performed by the MFP 101.

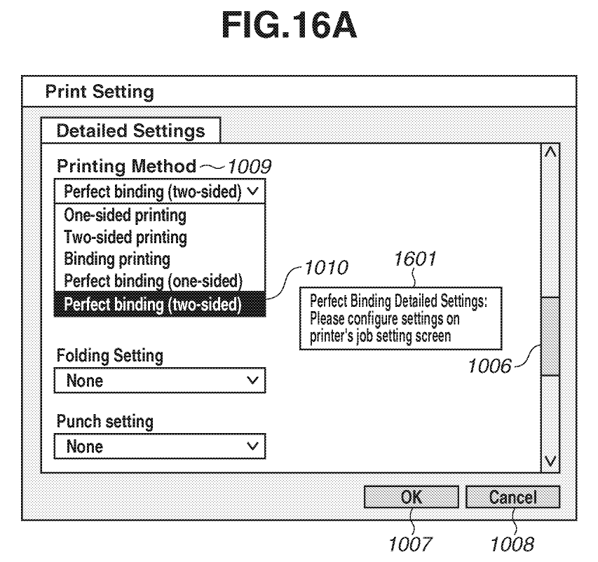

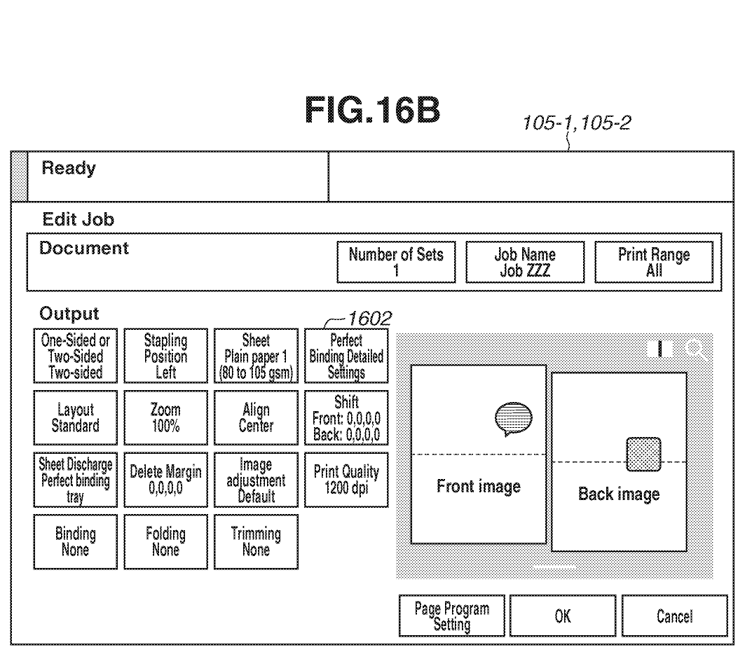

FIG. 16A illustrates an example of a print setting screen provided by a print setting extension application 303 according to the third embodiment, running on a client terminal 102. In the example of FIG. 16A, the option "perfect binding (two-sided)" 1010 is selected, but unlike the first embodiment, there is no [Binding Settings] button 1011. Instead, information 1601 is presented to notify the user that the binding setting function is implemented by the main body of the MFP 101.

FIG. 16B illustrates an example of a job setting screen displayed on an operation unit of the MFP 101, such as a monitor 105-1. In the third embodiment, in FIG. 16A, the perfect binding and perfect binding cover settings are not configured on the client terminal 102. Instead, the perfect binding, perfect binding cover, and other settings can be configured using a [Perfet Binding Detailed Settings] button 1602 of the MFP 101.

### FOURTH EMBODIMENT

The first embodiment has dealt with an example of the configuration where all the settings related to the perfect binding and the perfect binding cover can be implemented by the same module of the print setting extension application 303. FIGS. 14A and 14B also illustrate an example of the configuration where, when conditions corresponding to conflicting states occur in the settings that can be specified by the print setting extension application 303, the print setting extension application 303 according to the embodiment can perform processing for detecting and resolving the conflicting states.

A printing system according to a fourth embodiment is configured so that perfect binding and perfect binding cover settings are configured using the print setting extension application 303. Meanwhile, the detection and resolution of conflicts in the settings is performed by the MFP 101 using a job setting screen as illustrated in FIG. 16B, which is displayed on a monitor 105-1 that is an operation unit. This eliminates the need for excessive processing of the print setting extension application 303, even for functions involving an enormous and complex setting system like the perfect binding and perfect binding cover settings. Moreover, combination with the functions provided by the MFP 101 enables implementation of equivalent functions with a simpler method.

For example, even in the event of a conflict in the setting content between setting items and setting values, the setting units illustrated in FIG. 16B can efficiently provide information such as identification of the conflict, the content of the conflict, and procedures for resolution through the use of the functions of the job setting screen.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-029538, filed Feb. 26, 2025, which is hereby incorporated by reference herein in its entirety.

What is claimed is:

1. A method for controlling an information processing apparatus including a general-purpose printing program and an auxiliary printing program both configured to run on an operating system, a storage configured to store print settings, and a display, the method comprising:
determining, by the general-purpose printing program, that a perfect binding function is selected for an accepted print job; and
in response to the determination, controlling the auxiliary printing program to display a setting screen for the perfect binding function on the display and to accept one or more settings for the perfect binding function.

2. The method according to claim 1, wherein the perfect binding function includes a perfect binding book block setting function and a perfect binding cover setting function.

3. The method according to claim 1, wherein at least one of the general-purpose printing program and the auxiliary printing program includes a detection and resolution unit configured to detect and resolve conflicting print settings.

4. The method according to claim 3, wherein the detection and resolution unit is configured to disable conflicting setting items to prevent configuration of the setting items.

5. The method according to claim 4, wherein the conflicting setting items are setting of an insert tray as a sheet feeding unit and setting of cover printing.

6. The method according to claim 2, wherein the perfect binding cover setting function includes a spine width setting unit.

7. The method according to claim 6, wherein the spine width setting unit is configured to automatically set the spine width based on a thickness of the book block.

8. A printing system comprising:
an information processing apparatus and an image forming apparatus connected via a network,
wherein the information processing apparatus includes:
a general-purpose printing program and an auxiliary printing program both configured to run on an operating system;
a storage unit configured to store print settings; and
an operation unit,
wherein the general-purpose printing program is configured to, in response to determining that a perfect binding function is selected for an accepted print job, control the auxiliary printing program to display a setting screen for the perfect binding function on the operation unit and accept one or more settings,
wherein the auxiliary printing program is configured to provide part of the perfect binding function as a setting unit, and
wherein a setting item of the perfect binding function not provided by the auxiliary printing program is configured using a setting screen of the image forming apparatus connected via the network.

9. The printing system according to claim 8, wherein the information processing apparatus includes a notification unit configured to issue notification of information that the setting item of the perfect binding function not provided by the auxiliary printing program is to be configured using the image forming apparatus connected via the network.

10. The printing system according to claim 8, wherein the image forming apparatus includes a detection and resolution unit configured to detect and resolve conflicting print settings.

11. An information processing apparatus comprising:
a general-purpose printing program and an auxiliary printing program both configured to run on an operating system;
a storage configured to store print settings; and
a display,
wherein the general-purpose printing program is configured to, in response to determining that a perfect binding function is selected for an accepted print job when the general-purpose printing program accepts an instruction for print setting processing, control the auxiliary printing program to display a setting screen for the perfect binding function on the display and accept one or more settings for the perfect binding function.

12. An information processing apparatus comprising:
an operating system configured to run a general-purpose printing program and an auxiliary printing program; and
a display,
wherein a screen for the general-purpose printing program to accept print setting processing is displayed on the display,
wherein if a function for the auxiliary printing program to provide a setting of is selected on the screen, a screen for the auxiliary printing program to accept selection of a setting item related to the function is displayed on the display, and
wherein the auxiliary printing program is configured to, if a perfect binding function is selected within the function, display on the display a screen configured to accept a print setting of perfect binding.
